(19) United States
(12) Patent Application Publication
(10) Pub. No.: US 2011/0079078 A1
(43) Pub. Date: Apr. 7, 2011

(54) Fuel Level Sensor

(76) Inventors: Tan-Hsiung HO, Jhudong Township (TW); Chao-Hsi Su, Jhudong Township (TW)

(21) Appl. No.: 12/348,302

(22) Filed: Jan. 4, 2009

(51) Int. Cl. G01F 23/26

(52) U.S. Cl. 73/304 C

(57) ABSTRACT

An fuel level detector includes a substrate fixedly mounted inside an fuel tank, a narrow elongated first electrode arranged on the substrate and kept in contact with the fuel oil in the fuel tank, a second electrode formed of a plurality of electrode elements arranged on the substrate at different elevations in a parallel manner relative to the first electrode, and a sensing circuit formed of a plurality of capacitive sensors that are respectively electrically connected with the electrode elements of the second electrode for detecting the level of fuel oil in the fuel tank subject to a rise in capacitance value between the first electrode and one electrode element of the second electrode.

### BACKGROUND OF THE INVENTION

1. Field of the Invention

The present invention relates to fuel level detection technology and more particularly, to a fuel level detector for use to detect the level of fuel oil in a fuel tank.

2. Description of the Related Art

The fuel level of the fuel oil in the fuel tank of a mechanical device (machine or motor vehicle) will be lowered following running of the mechanical device. Therefore, a gauge is usually used in a mechanical device to indicate the remaining amount of the fuel oil. Conventional fuel level detectors commonly use a float to detect the fuel level of the fuel oil in the fuel tank of a mechanical device. The float moves with the fuel level of the fuel oil, causing the angle of a lever to be biased subject to the change of the elevation of the fuel level. A float-based fuel level detector requires a broad space for the movement of the lever. In consequence, the shape of the fuel tank cannot be freely changed to fit different mechanical devices. To eliminate this problem, the present inventor creased a fuel level detect using a sensor and two electrodes. The two electrodes are inserted into the fuel tank and kept in contact with the fuel oil in the fuel tank. The sensor senses the equivalent capacitance value between the two electrodes, and then converts the detected equivalent capacitance value into a reading indicative of the fuel level. This design requires less installation space in the fuel tank. However, this design of fuel level detector still has drawbacks. Before use, it is necessary to measure the capacitance value between the two electrodes when the fuel tank is empty and the capacitance value between the two electrodes when the fuel level of the fuel in the fuel tank is full, and then the relative capacitance value is calculated subject to the height of the fuel tank. This operation procedure is complicated. Further, when the type of the storage fuel oil is changed, an additional compensation electrode must be installed in the fuel tank to compensate the difference.

### SUMMARY OF THE INVENTION

The present invention has been accomplished under the circumstances in view. It is one object of the present invention to provide a fuel level detector, which detects the fuel level in a fuel tank accurately. It is another object of the present invention to provide a fuel level detector, which is easy to use, eliminating the procedure of detecting the capacitance value before use or installing an additional compensation electrode upon change of the type of the fuel oil.

To achieve these and other objects of the present invention, the fuel level detector comprises a substrate fixedly mounted inside a fuel tank and carrying a first electrode and a second electrode in a parallel manner, and a sensing circuit mounted on the top side of the substrate and electrically connected with the first electrode and the second electrode. The first electrode is a narrow, elongated, single-piece electrode. The second electrode comprises a plurality of electrode elements arranged on the substrate at different elevations in a parallel manner relative to the first electrode. The sensing circuit comprises a plurality of capacitive sensors respectively electrically connected with the electrode elements of the second electrode. The sensing circuit detects the level of fuel oil in the fuel tank subject to a rise in capacitance value between the first electrode and one electrode element of the second electrode.

### BRIEF DESCRIPTION OF THE DRAWINGS

FIG. 1 is a schematic drawing showing a fuel level detector in accordance with a first embodiment of the present invention.

FIG. 2 is a chart showing a variation in capacitance value between the first electrode and second electrode of the fuel level detector in accordance with the present invention.

FIG. 3 illustrates a fuel level detector in accordance with a second embodiment of the present invention.

### DETAILED DESCRIPTION OF THE PREFERRED EMBODIMENT

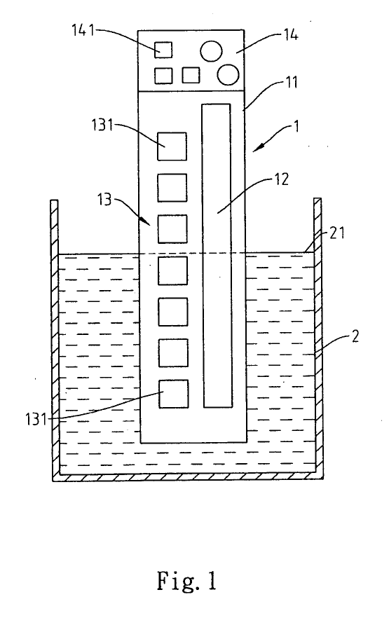

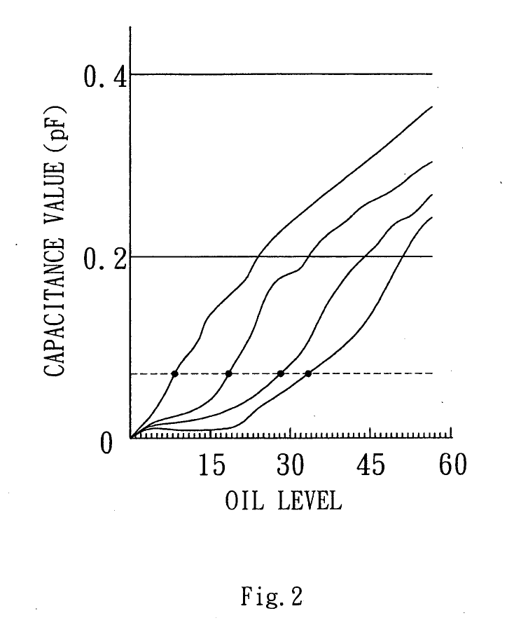

Referring to FIGS. 1 and 2, a fuel level detector 1 comprises a substrate 11, a first electrode 12 and a second electrode 13 mounted on one side of the substrate 11 and arranged in a parallel manner, and a sensing circuit 14 mounted on the substrate 11 near one end. The substrate 11 is a narrow elongated strip. The first electrode 12 is a narrow elongated electrode extending along the length of the substrate 11. The second electrode 13 comprises a plurality of electrode elements 131 arranged on the substrate 11 in a line. The sensing circuit 14 comprises a plurality of capacitive sensors 141 respectively electrically connected with the electrode elements 131 of the second electrode 13.

When using the fuel level detector 1 to detect the fuel level 21 in a fuel tank 2 of a machine or vehicle, the fuel level detector 1 is fixedly mounted inside the fuel tank 2 in vertical, and then the sensing circuit 14 is electrically connected to a gauge (not shown). When the fuel level 21 touches one electrode element 131 of the second electrode 13, the capacitance value between the electrode element 131 where the fuel level 21 touches and the first electrode 12 rises and is sensed by the respective capacitive sensor 141, which provides a signal indicative of the height of the fuel level to the gauge, causing the gauge to indicate the height of the fuel level 21 in the fuel tank 2. According to this embodiment, the sensitivity (accuracy) of the fuel level detector 1 is determined subject to the number of the electrode elements 131 of the second electrode 13. Further, the fuel level detector 1 is practical for use in a mower, motor vehicle or radio control model to detect the level of fuel oil. Further, the substrate 11 can be a printed circuit board.

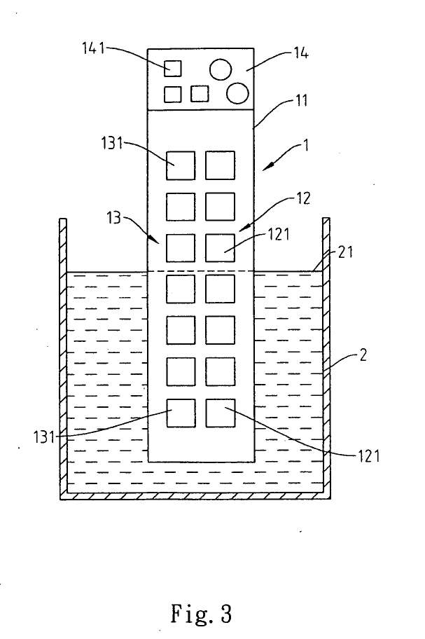

FIG. 3 illustrates a fuel level detector in accordance with a second embodiment of the present invention. This second embodiment is substantially similar to the aforesaid first embodiment with the exception that the first electrode 12 of this second embodiment is comprised of a plurality of electrode elements 121 arranged in line corresponding to the electrode elements 131 of the second electrode 13. This second embodiment achieves the same effect as the aforesaid first embodiment. Because the functioning of this second embodiment is same as the aforesaid first embodiment, no further detailed description in this regard is necessary.

As stated above, the invention detects the fuel level by means of sensing the change of capacitance value between the first electrode 12 and one electrode element 131 of the second electrode 13. Therefore, the height of the fuel level 21 indicated by the gauge is determined subject to a rise in capacitance value between the first electrode 12 and one electrode element 131 of the second electrode 13, having no concern with the shape of the fuel tank 2 or the type of fuel oil contained in the fuel tank 2.

What the invention claimed is:

1. An fuel level detector for detecting the level of a fuel oil contained in an fuel tank, comprising:
a substrate;
first electrode means mounted on one side of said substrate for contacting the fuel oil in the fuel tank to be measured;
second electrode means mounted on said substrate in parallel to said first electrode means; and
a sensing circuit mounted on a top side of said substrate and electrically connected with said first electrode means and said second electrode means for sensing the elevation of the fuel oil that touches said first electrode means and said second electrode means;
wherein:
said second electrode means comprises a plurality of electrode elements arranged on said substrate at different elevations and vertically aligned in line;
said sensing circuit comprises a plurality of capacitive sensors respectively electrically connected with the electrode elements of said second electrode means.

2. The fuel level detector as claimed in claim 1, wherein said substrate is fixedly mounted inside the fuel tank to be detected and extending from a bottom side of said fuel tank toward a top side of said fuel tank.

3. The fuel level detector as claimed in claim 1, wherein said sensing circuit is electrically connected to a gauge in a mechanical device carrying the fuel tank.

4. The fuel level detector as claimed in claim 1, wherein said substrate is a circuit board.

5. The fuel level detector as claimed in claim 1, wherein said first electrode means comprises a plurality of electrode elements arranged on said substrate at different elevations and vertically aligned in line in a parallel manner relative to the electrode elements of said second electrode means.
